(19) United States
(12) Patent Application Publication
(10) Pub. No.: US 2026/0113592 A1
(43) Pub. Date: Apr. 23, 2026

(54) AUDIO PROCESSING METHOD AND ELECTRONIC DEVICE

(71) Applicant: HUAWEI TECHNOLOGIES CO., LTD., Shenzhen (CN)

(72) Inventors: Jing Yang, Shenzhen (CN); Yuhao Sun, Shenzhen (CN); Fan Fan, Shenzhen (CN); Lei Guo, Shenzhen (CN); Xiang Wei, Shenzhen (CN)

(73) Assignee: HUAWEI TECHNOLOGIES CO., LTD., Shenzhen (CN)

(21) Appl. No.: 19/423,523

(22) Filed: Dec. 17, 2025

Related U.S. Application Data
(63) Continuation of application No. PCT/CN2024/112173, filed on Aug. 14, 2024.

(30) Foreign Application Priority Data
Aug. 15, 2023 (CN) 202311035340.3

(51) Int. Cl. H04S 7/00

(52) U.S. Cl. CPC H04S 7/304; H04S 2400/11

(57) ABSTRACT

Embodiments of this application provide an audio processing method and an electronic device. The method includes: First, a source audio signal, a sound source position corresponding to the source audio signal in a virtual scene, and a first position corresponding to a user in the virtual scene are obtained, where the virtual scene is obtained through construction based on a real scene; and a first acoustic feature is obtained, where the first acoustic feature is obtained by converting, based on an acoustic feature at a second position in the real scene and an acoustic feature at the second position in the virtual scene, an acoustic feature at the first position in the virtual scene when the source audio signal is at the sound source position. Then, a spatial audio signal is generated based on the first acoustic feature and the source audio signal.

### CROSS-REFERENCE TO RELATED APPLICATIONS

This application is a continuation of international application No. PCT/CN2024/112173, filed on Aug. 14, 2024, which claims priority to Chinese Patent Application No. 202311035340.3, filed on Aug. 15, 2023. The disclosures of the aforementioned applications are hereby incorporated by reference in their entireties.

### TECHNICAL FIELD

Embodiments of this application relate to the audio processing field, and in particular, to an audio processing method and an electronic device.

### BACKGROUND

Currently, many electronic devices (such as a mobile phone, an augmented reality (AR) device, and a virtual reality (VR) device) have a spatial audio function, and can render a source audio signal into a spatial audio signal, allowing a user to perceive a sound image position, a sense of distance, and a sense of space in audio, thereby bringing immersive listening experience to the user.

Usually, a method for rendering the source audio signal into the spatial audio signal is to render the source audio signal by using an acoustic response of target space. However, an acoustic response generated by using an existing computing technology is usually different from an acoustic response in a real scene to some extent. Consequently, the user experiences a spatial audio signal with low quality and a diminished sense of immersion.

### SUMMARY

To resolve the foregoing technical problem, this application provides an audio processing method and an electronic device, so that a user can experience a spatial audio signal with high quality and a heightened sense of immersion.

It should be noted that application scenarios of this application may include: a scenario in which the user uses an AR/VR device to experience an AR/VR project (for example, an AR/VR science lecture, an AR/VR cinema, or an AR/VR concert), and a scenario in which the user uses a headset and a terminal device such as a mobile phone, a tablet computer, a notebook computer, a personal computer, or a smartwatch to experience a listening project (for example, crosstalk, a movie, a live concert, or a concert).

According to a first aspect, an embodiment of this application provides an audio processing method. The method includes: First, a source audio signal, a sound source position corresponding to the source audio signal in a virtual scene, and a first position corresponding to a user in the virtual scene are obtained, where the virtual scene is obtained through modeling based on a real scene; and a first acoustic feature is obtained based on the sound source position and the first position, where the first acoustic feature is obtained by adjusting a second acoustic feature based on conversion information, the second acoustic feature is obtained by performing acoustic feature extraction based on the first position, the virtual scene, and the sound source position, and the conversion information is used to describe a conversion relationship between acoustic features at a same position in the virtual scene and the real scene. Then, a spatial audio signal is generated based on the first acoustic feature and the source audio signal.

In other words, in this application, an acoustic feature (namely, the second acoustic feature) of the first position currently corresponding to the user in the virtual scene is adjusted based on the conversion relationship between acoustic features at a same position in the virtual scene and the real scene, so that an acoustic feature (namely, the first acoustic feature) of the first position corresponding to the user in the virtual scene is closer to an acoustic feature at a position of the user in the real scene corresponding to the virtual scene. In this way, a spatial audio signal subsequently generated based on the adjusted acoustic feature (namely, the first acoustic feature) is closer to a spatial audio signal heard by the user at the position in the real scene corresponding to the virtual scene, so that the user can experience a spatial audio signal with high quality and a heightened sense of immersion.

It should be noted that the conversion information may be used to adjust a second acoustic feature at any first position in the virtual environment, to obtain a corresponding first acoustic feature.

For example, the virtual scene in which the user is located may be a virtual scene corresponding to a listening project or AR/VR project selected (or experienced) by the user. For example, a listening project is a live concert, and a corresponding virtual scene is a virtual stadium or a virtual studio; a listening project is a movie, and a corresponding virtual scene is a virtual cinema; an AR/VR project is a concert, and a corresponding virtual scene is a virtual concert hall; and an AR/VR project is a lecture, and a corresponding virtual scene is a virtual lecture hall. In other words, the virtual scene in which the user is located may be a virtual scene corresponding to a spatial audio signal experienced by the user.

For example, the virtual scene is obtained through modeling based on the real scene, and the virtual scene may be generated in a plurality of manners. This is not limited in this application. The real scene is an objective scene, for example, a cinema, a concert hall, or a lecture hall. The virtual scene is a scene constructed by using a virtual technology, and is not an objective scene. The virtual scene corresponding to the listening project (or the AR/VR project) selected (or experienced) by the user is obtained through modeling based on the real scene. For example, a virtual concert hall is obtained through modeling based on a real concert hall. For another example, a virtual cinema is obtained through modeling based on a real cinema. For still another example, a virtual lecture hall is obtained through modeling based on a real lecture hall.

It should be noted that a real scene in which the user is currently located and the virtual scene corresponding to the listening project (or the AR/VR project) selected (or experienced) by the user may be a same scene, or may not be a same scene. This is not limited in this application. In other words, the real scene in which the user is currently located and the real scene used for modeling to obtain the virtual scene corresponding to the listening project (or the AR/VR project) selected (or experienced) by the user may be a same scene, or may not be a same scene. This is not limited in this application.

For example, when the real scene in which the user is currently located and the virtual scene corresponding to the listening project (or the AR/VR project) selected (or experienced) by the user are a same scene, a position of the user in the real scene is the same as a corresponding position of the user in the virtual scene, that is, the position of the user in the real scene is the first position.

For example, when the real scene in which the user is currently located and the virtual scene corresponding to the listening project (or the AR/VR project) selected (or experienced) by the user are not a same scene, in an embodiment, a default position may be determined as the first position corresponding to the user in the virtual scene. The default position may be set based on a requirement, for example, may be a position with optimal audio experience in the virtual scene. This is not limited in this application. In an embodiment, a terminal device may provide a position option in the virtual scene. In this way, the user may select a position option corresponding to a required experience position in the virtual scene. Further, the terminal device may use a position corresponding to the position option selected by the user as the first position corresponding to the user in the virtual scene.

For example, there may be a plurality of modeling manners, for example, manual modeling, modeling based on visual information, and modeling based on auditory information. This is not limited in this application.

For example, spatial audio processing (for example, rendering) may be performed based on the first acoustic feature and the source audio signal, to generate the spatial audio signal (for example, a binaural-rendered signal).

For example, the source audio signal may include an audio file (for example, a music file or a crosstalk file), or an audio file included in a multimedia file (for example, an audio file included in a movie file).

For example, the first acoustic feature may be generated in advance and stored in a database, or may be generated in real time. This is not limited in this application.

For example, the second acoustic feature may be generated in advance and stored in a database, or may be generated in real time. This is not limited in this application.

For example, the conversion information may be generated in advance and stored in a database, or may be generated in real time. This is not limited in this application.

It should be noted that the first acoustic feature, the second acoustic feature, and the conversion information may be stored in a same database or different databases.

For example, acoustic feature extraction manners may include but are not limited to acoustic simulation, machine learning, and numerical computation. This is not limited in this application.

In some embodiments, the conversion information is determined by analyzing an acoustic feature group, the acoustic feature group includes a third acoustic feature and a fourth acoustic feature, the fourth acoustic feature is an acoustic feature at a second position in the real scene, and the third acoustic feature is an acoustic feature at the second position in the virtual scene. In this way, an accurate conversion relationship between acoustic features at a same position in the real scene and the virtual scene can be determined by obtaining and analyzing the acoustic features at the same position in the real scene and the virtual scene.

In some embodiments, there are one or more acoustic feature groups, there are one or more second positions, and a third acoustic feature and a fourth acoustic feature that belong to a same acoustic feature group correspond to a same second position.

For example, when the real scene is a uniform room (for example, a square room with consistent wall materials, where the room may be understood as an indoor scene), and a difference between real acoustic features at different positions is small, there may be one second position, so that workload can be reduced. For another example, when the real scene is a non-uniform room (for example, an asymmetric room with diversified wall materials), and a difference between real acoustic features at different positions is large, there may be a plurality of second positions, so that accuracy of generated conversion information can be improved. It should be understood that a quantity of second positions may be determined based on a requirement. This is not limited in this application.

For example, when sound source devices are deployed at different positions (referred to as preset sound source positions below) in the real scene, fourth acoustic features at a same position are different. Correspondingly, when virtual sound sources are deployed at different preset sound source positions in the virtual scene, third acoustic features at a same position are different. In other words, in the real scene, each second position corresponds to one or more fourth acoustic features; and in the virtual scene, each second position corresponds to one or more third acoustic features. Therefore, one second position may correspond to one or more acoustic feature groups, and a third acoustic feature and a fourth acoustic feature that belong to a same acoustic feature group correspond to a same second position and a same preset sound source position.

It should be noted that, in this application, only a conversion relationship between acoustic features at one or more positions (namely, one or more second positions) in the virtual scene and the real scene needs to be analyzed, to obtain conversion information. In addition, the conversion information has universality at any position in a same room (that is, a same virtual scene), and is not only used to adjust an acoustic feature at a first position close to the second position.

In some embodiments, the conversion information includes a conversion function, and the conversion function is obtained by analyzing signal processing results of the third acoustic feature and the fourth acoustic feature.

For example, signal processing may be separately performed on a third acoustic feature and a fourth acoustic feature in one acoustic feature group, to obtain signal processing results. Then, a signal processing result of the third acoustic feature and a signal processing result of the fourth acoustic feature are analyzed, to obtain a conversion function. In this case, the conversion function may be used as conversion information. For example, for a third acoustic response, for example, a room impulse response (RIR), included in the third acoustic feature and a fourth acoustic response, for example, an RIR, included in the fourth acoustic feature, where the third acoustic feature is represented by an RIR 1, and the fourth acoustic feature is represented by an RIR 2, frequency domain conversion may be separately performed on the RIR 1 and the RIR 2, to obtain a frequency domain response (referred to as a frequency response 1) of the RIR 1 and a frequency domain response (referred to as a frequency response 2) of the RIR 2. Then, in an embodiment, a frequency response conversion function may be calculated by using the frequency response 1 and the frequency response 2, and the frequency response conversion function is used as the conversion function; and in an embodiment, signal analysis may be separately performed on the frequency response 1 and the frequency response 2, and then the conversion function is determined based on signal analysis results.

In some embodiments, the conversion information includes a feature change rate, and the feature change rate is a change rate of the third acoustic feature relative to the fourth acoustic feature.

For example, numerical analysis may be separately performed on a third acoustic feature and a fourth acoustic feature in one acoustic feature group, to obtain a feature change rate. In this case, the feature change rate may be used as conversion information. Specifically, a change rate of the third acoustic feature in the acoustic feature group relative to the fourth acoustic feature in the acoustic feature group may be calculated as the feature change rate. For example, for a third acoustic parameter, for example, a direct-to-reverberation energy ratio, included in the third acoustic feature and a fourth acoustic parameter, for example, a direct-to-reverberation energy ratio, included in the fourth acoustic feature, where the direct-to-reverberation energy ratio in the third acoustic parameter is represented by a DRR 1, and the direct-to-reverberation energy ratio in the fourth acoustic parameter is represented by a DRR 2, a corresponding feature change rate may be (DRR 1-DRR 2)/DRR 2 or DRR 1/DRR 2. It should be understood that the conversion information may include a plurality of feature change rates (the plurality of feature change rates are in a one-to-one correspondence with a plurality of acoustic parameters). This is not limited in this application.

In some embodiments, the conversion information includes model output information obtained after the third acoustic feature and the fourth acoustic feature are input into a model.

For example, a third acoustic feature and a fourth acoustic feature in one acoustic feature group may be processed in a machine learning manner, to obtain conversion information. Specifically, a third acoustic feature and a fourth acoustic feature in one acoustic feature group may be input to an AI model (or referred to as a machine learning model, which is referred to as a second model below), and the second model processes the third acoustic feature and the fourth acoustic feature in the acoustic feature group to output conversion information. In other words, model output information of the second model is the conversion information.

For example, the model output information may include a conversion function, a feature change rate, and information in another form. This is not limited in this application.

It should be understood that the conversion information may alternatively be generated in another manner. This is not limited in this application.

In some embodiments, the first acoustic feature includes at least one of the following: an acoustic response, energy information, an acoustic parameter, or a derived acoustic feature.

The acoustic response may include but is not limited to a room impulse response, a binaural room impulse response (BRIR), and a higher order ambisonics (HOA).

The energy information may include energy distribution, energy attenuation, and the like, corresponding to the acoustic response, across a plurality of frequency bands and a plurality of directions.

The acoustic parameter may include an environmental acoustic parameter and a binaural acoustic parameter. The environmental acoustic parameter includes but is not limited to a direct-to-reverberation energy ratio (DRR), reverberation time (Reverberation Time) (for example, T20 (time at which energy is attenuated by 20 dB), T30, or T60), a clarity (Clarity) (for example, C50 (a ratio of sound energy before and after 50 ms), or C80). The binaural acoustic parameter may include but is not limited to an interaural time difference (ITD), an interaural level difference (ILD), and an interaural cross correlation (IACC).

The derived acoustic feature may include a numerical analysis feature obtained by performing numerical analysis (for example, principal component analysis (PCA)) on the acoustic parameter, and may further include output information of an AI model (referred to as a first model below) obtained by inputting at least one of the acoustic response, the energy information, or the acoustic parameter into the first model.

In some embodiments, the fourth acoustic feature is obtained by processing a test audio signal received at the second position in the real scene.

For example, a sound source device may be deployed in the real scene. After the user moves to the second position with a receiving device, the sound source device may be controlled to play the test audio signal. Correspondingly, the receiving device at the second position may receive the test audio signal. Then, the receiving device may process the received test audio signal to obtain the fourth acoustic feature. It should be understood that the fourth acoustic feature is a real acoustic feature.

For example, the sound source device plays a test audio signal such as a pulse signal, a noise signal, or a sweep signal, and the receiving device at the second position receives and processes the test audio signal, to obtain an acoustic response in a format such as an RIR, a BRIR, or an HOA.

For another example, the sound source device plays a sound signal such as a pulse signal, a noise signal, or a sweep signal, and the receiving device at the second position receives and processes the test audio signal, to obtain energy information, an acoustic parameter, a derived acoustic feature, and the like.

For another example, the sound source device plays a natural audio signal (such as a voice, a song, pure music, or a video), and the receiving device at the second position receives and processes the test audio signal, to obtain an acoustic response in a format such as an RIR, a BRIR, or an HOA.

For another example, the sound source device plays a natural audio signal (such as a voice, a song, pure music, or a video), and the receiving device at the second position receives and processes the test audio signal, to obtain energy information, an acoustic parameter, a derived acoustic feature, and the like.

The sound source device includes but is not limited to a speaker device (for example, a home audio system), a terminal device (for example, a tablet computer or a large screen) with an external play function, and a professional acoustic measurement device.

The receiving device includes but is not limited to a terminal device (for example, a tablet computer, a mobile phone, or an AR/VR device) including a microphone and a professional acoustic measurement device.

In some embodiments, the fourth acoustic feature is input by the user in a defined manner.

In some real scenes, acoustic features obtained through actual measurement may not necessarily be closest to acoustic features that match actual auditory perception of the user. Therefore, the acoustic features that match the actual auditory perception of the user in the real scenes are directly input, so that adjusted acoustic features are closer to the acoustic features that match the actual auditory perception of the user in the real scenes. In this way, spatial audio signals subsequently generated based on the adjusted acoustic features are closer to spatial audio signals heard by the user at positions in the real scenes corresponding to some virtual scenes.

For example, “some real scenes” may include: a real scene in which there is inevitable interference noise, a real scene in which visual presentation of a surface material does not match actual acoustic effect of the surface material, and a real scene used as a multi-functional space (for example, a real scene used as a lecture hall, a concert hall, and a movie and television hall).

In some embodiments, obtaining the first acoustic feature based on the sound source position and the first position includes: determining one or more acoustic feature groups, where one acoustic feature group includes a third acoustic feature and a fourth acoustic feature, the fourth acoustic feature is an acoustic feature at a second position in the real scene, and the third acoustic feature is an acoustic feature at the second position in the virtual scene; analyzing a third acoustic feature and a fourth acoustic feature in the one or more acoustic feature groups to obtain conversion information; performing acoustic feature extraction based on the first position, the virtual scene, and the sound source position, to obtain a second acoustic feature; and adjusting the second acoustic feature based on the conversion information, to obtain the first acoustic feature.

In this case, the real scene in which the user is currently located and the virtual scene corresponding to the listening project (or the AR/VR project) selected (or experienced) by the user are a same scene, so that the conversion information, the second acoustic feature, and the first acoustic feature can be generated in real time.

In some embodiments, obtaining the first acoustic feature based on the sound source position and the first position includes: selecting, from a plurality of second acoustic feature sets stored in a database, a second acoustic feature set corresponding to the virtual scene, where the plurality of second acoustic feature sets are in a one-to-one correspondence with a plurality of preset virtual scenes, one second acoustic feature set includes a plurality of second preset acoustic features, one second acoustic feature set is obtained by performing acoustic feature extraction based on one preset virtual scene, a plurality of fourth positions, and a plurality of preset sound source positions, and one fourth position and one preset sound source position are used to determine one second preset acoustic feature in one second acoustic feature set; selecting, based on the sound source position and the first position, a second acoustic feature from the second acoustic feature set corresponding to the virtual scene; selecting, based on the virtual scene, conversion information from a plurality of pieces of preset conversion information stored in a database, where the plurality of pieces of preset conversion information are in a one-to-one correspondence with the plurality of preset virtual scenes; and adjusting the second acoustic feature based on the conversion information, to obtain the first acoustic feature.

In this case, the real scene in which the user is currently located and the virtual scene corresponding to the listening project (or the AR/VR project) selected (or experienced) by the user may be a same scene, or may not be a same scene. In this way, the terminal device does not need to generate the conversion information and the second acoustic feature in real time, so that time for generating the spatial audio signal can be shortened, and user experience can be improved. In addition, a virtual scene that may be used for a plurality of times at different time, by different users, or in different applications may alternatively be invoked in a more efficient manner.

In some embodiments, obtaining the first acoustic feature based on the sound source position and the first position includes: selecting, from a plurality of first acoustic feature sets stored in a database, a first acoustic feature set corresponding to the virtual scene, where the plurality of first acoustic feature sets are in a one-to-one correspondence with a plurality of preset virtual scenes, the plurality of first acoustic feature sets are in a one-to-one correspondence with a plurality of second acoustic feature sets, one second acoustic feature set is obtained by performing acoustic feature extraction based on one preset virtual scene, a plurality of third positions, and a plurality of preset sound source positions, one third position and one preset sound source position are used to determine one second preset acoustic feature in one second acoustic feature set, and one first preset acoustic feature in one first acoustic feature set is obtained by adjusting one second preset acoustic feature in a corresponding second acoustic feature set based on conversion information; and selecting, based on the sound source position and the first position, the first acoustic feature from the first acoustic feature set corresponding to the virtual scene.

In this case, the real scene in which the user is currently located and the virtual scene corresponding to the listening project (or the AR/VR project) selected (or experienced) by the user may be a same scene, or may not be a same scene. In this way, the terminal device does not need to generate the conversion information, the second acoustic feature, and the first acoustic feature in real time, so that time for generating the spatial audio signal can be further shortened, and user experience can be improved. In addition, a virtual scene that may be used for a plurality of times at different time, by different users, or in different applications may alternatively be invoked in a more efficient manner.

According to a second aspect, an embodiment of this application provides an audio processing apparatus. The apparatus includes:
a first obtaining module, configured to obtain a source audio signal, a sound source position corresponding to the source audio signal in a virtual scene, and a first position corresponding to a user in the virtual scene, where the virtual scene is obtained through modeling based on a real scene;
a second obtaining module, configured to obtain a first acoustic feature based on the sound source position and the first position, where the first acoustic feature is obtained by adjusting a second acoustic feature based on conversion information, the second acoustic feature is obtained by performing acoustic feature extraction based on the first position, the virtual scene, and the sound source position, and the conversion information is used to describe a conversion relationship between acoustic features at a same position in the virtual scene and the real scene; and
an audio signal generation module, configured to generate a spatial audio signal based on the first acoustic feature and the source audio signal.

It should be understood that the audio processing apparatus in the second aspect may perform any one of the implementations of the first aspect. Details are not described herein again.

Any one of the second aspect and the implementations of the second aspect corresponds to any one of the first aspect and the implementations of the first aspect. For technical effect corresponding to any one of the second aspect and the implementations of the second aspect, refer to technical effect corresponding to any one of the first aspect and the implementations of the first aspect. Details are not described herein again.

According to a third aspect, an embodiment of this application provides an electronic device. The electronic device includes a memory and a processor. The memory is coupled to the processor, and the memory stores program instructions. When the program instructions are executed by the processor, the electronic device is enabled to perform the audio processing method according to any one of the first aspect or the possible implementations of the first aspect.

Any one of the third aspect and the implementations of the third aspect corresponds to any one of the first aspect and the implementations of the first aspect. For technical effect corresponding to any one of the third aspect and the implementations of the third aspect, refer to technical effect corresponding to any one of the first aspect and the implementations of the first aspect. Details are not described herein again.

According to a fourth aspect, an embodiment of this application provides a chip. The chip includes one or more interface circuits and one or more processors. The one or more processors receive or send data through the one or more interface circuits. When the one or more processors execute computer instructions, operations of the audio processing method according to any one of the first aspect or the possible implementations of the first aspect are performed.

Any one of the fourth aspect and the implementations of the fourth aspect corresponds to any one of the first aspect and the implementations of the first aspect. For technical effect corresponding to any one of the fourth aspect and the implementations of the fourth aspect, refer to technical effect corresponding to any one of the first aspect and the implementations of the first aspect. Details are not described herein again.

According to a fifth aspect, an embodiment of this application provides a computer-readable storage medium. The computer-readable storage medium stores a computer program. When the computer program is run on a computer or a processor, the computer or the processor is enabled to perform the audio processing method according to any one of the first aspect or the possible implementations of the first aspect.

Any one of the fifth aspect and the implementations of the fifth aspect corresponds to any one of the first aspect and the implementations of the first aspect. For technical effect corresponding to any one of the fifth aspect and the implementations of the fifth aspect, refer to technical effect corresponding to any one of the first aspect and the implementations of the first aspect. Details are not described herein again.

According to a sixth aspect, an embodiment of this application provides a computer program product. The computer program product includes computer instructions. When the computer instructions are executed by a computer or a processor, the computer or the processor is enabled to perform the audio processing method according to any one of the first aspect or the possible implementations of the first aspect.

Any one of the sixth aspect and the implementations of the sixth aspect corresponds to any one of the first aspect and the implementations of the first aspect. For technical effect corresponding to any one of the sixth aspect and the implementations of the sixth aspect, refer to technical effect corresponding to any one of the first aspect and the implementations of the first aspect. Details are not described herein again.

According to a seventh aspect, an embodiment of this application provides an augmented reality AR device, where the AR device includes a display module, an image capture module, a headset, and a processor.

The processor is configured to perform the audio processing method according to any one of the first aspect or the possible implementations of the first aspect.

The headset is configured to play the spatial audio signal generated by using the audio processing method according to any one of the first aspect or the possible implementations of the first aspect.

For example, the display module may be configured to display an image, and the image capture module is configured to capture an image.

Any one of the seventh aspect and the implementations of the seventh aspect corresponds to any one of the first aspect and the implementations of the first aspect. For technical effect corresponding to any one of the seventh aspect and the implementations of the seventh aspect, refer to technical effect corresponding to any one of the first aspect and the implementations of the first aspect. Details are not described herein again.

According to an eighth aspect, an embodiment of this application provides an augmented reality VR device, where the VR device includes a display module, an image capture module, a headset, and a processor.

The processor is configured to perform the audio processing method according to any one of the first aspect or the possible implementations of the first aspect.

The headset is configured to play the spatial audio signal generated by using the audio processing method according to any one of the first aspect or the possible implementations of the first aspect.

For example, the display module may be configured to display an image, and the image capture module is configured to capture an image.

Any one of the eighth aspect and the implementations of the eighth aspect corresponds to any one of the first aspect and the implementations of the first aspect. For technical effect corresponding to any one of the eighth aspect and the implementations of the eighth aspect, refer to technical effect corresponding to any one of the first aspect and the implementations of the first aspect. Details are not described herein again.

According to a ninth aspect, this application provides an audio processing method. The method includes: First, a source audio signal, a sound source position corresponding to the source audio signal in a virtual scene, and a first position corresponding to a user in the virtual scene are obtained, where the virtual scene is obtained through construction based on a real scene. Then, a first acoustic feature is obtained, where the first acoustic feature is obtained by converting, based on an acoustic feature at a second position in the real scene and an acoustic feature at the second position in the virtual scene, an acoustic feature at the first position in the virtual scene when the source audio signal is at the sound source position. Then, a spatial audio signal is generated based on the first acoustic feature and the source audio signal.

In an embodiment, the virtual scene is obtained through modeling based on the real scene.

For example, the acoustic feature at the second position in the real scene may be a fourth acoustic feature in the following specific implementations.

For example, the acoustic feature at the first position in the virtual scene when the source audio signal is at the sound source position may be a second acoustic feature in the following specific implementations.

For example, the acoustic feature at the second position in the virtual scene may be a third acoustic feature in the following specific implementations.

In an embodiment, obtaining the first acoustic feature may include: converting the acoustic feature at the first position in the virtual scene based on the acoustic feature at the second position in the real scene and the acoustic feature at the second position in the virtual scene, to obtain the first acoustic feature. In other words, in an application process, the acoustic feature at the first position in the virtual scene is converted in real time, to obtain the first acoustic feature.

In an embodiment, obtaining the first acoustic feature may include: selecting, from a plurality of first acoustic feature sets that correspond to a plurality of preset virtual scenes and that are stored in a database, a first acoustic feature set corresponding to the virtual scene; and selecting, based on the sound source position and the first position, the first acoustic feature from the first acoustic feature set corresponding to the virtual scene. In other words, first acoustic features at a plurality of positions are determined in advance, and in an application process, the database is searched for a first acoustic feature that matches a current situation (that is, the current sound source position and first position).

According to a ninth aspect, the first acoustic feature includes at least one of the following: an acoustic response, energy information, an acoustic parameter, or a derived acoustic feature.

In some embodiments, there are one or more second positions.

In some embodiments, first positions corresponding to the user in the virtual scene at different moments are the same or different.

In some embodiments, the second position is the same as or different from the first position.

In some embodiments, the spatial audio signal generated based on the first acoustic feature and the source audio signal is different from a spatial audio signal generated based on the acoustic feature at the first position in the virtual scene and the source audio signal.

In some embodiments, the method further includes: reading the acoustic feature at the second position in the real scene from a database.

In some embodiments, the acoustic feature at the second position in the real scene is obtained by a professional acoustic measurement device by performing environmental acoustic feature collection.

In some embodiments, the method further includes: obtaining a user-defined acoustic feature at the second position in the real scene.

In some embodiments, before obtaining the source audio signal, the sound source position corresponding to the source audio signal in the virtual scene, and the first position corresponding to the user in the virtual scene, the method further includes: obtaining a user operation performed by the user on a user interface; and generating the acoustic feature at the second position in the real scene based on the user operation.

In some embodiments, before obtaining the source audio signal, the sound source position corresponding to the source audio signal in the virtual scene, and the first position corresponding to the user in the virtual scene, the method further includes: obtaining position information of the user; and when it is determined based on the position information that the user moves to the second position, generating the acoustic feature at the second position in the real scene.

In some embodiments, the method further includes: obtaining the acoustic feature at the second position in the real scene based on the sound source position, the first position, and the second position.

For technical effect corresponding to any one of the ninth aspect and the implementations of the ninth aspect, refer to technical effect corresponding to any one of the first aspect and the implementations of the first aspect. Details are not described herein again.

In addition, this application further provides an audio processing apparatus, an augmented reality AR device, a virtual reality VR device, an electronic device, a chip, a computer-readable storage medium, a computer program product, and the like that are configured to perform the method according to any one of the first aspect and the implementations of the first aspect.

### BRIEF DESCRIPTION OF DRAWINGS

FIG. 1A is a diagram of an example of an application scenario according to some embodiments;

FIG. 1B is a diagram of an example of an application scenario according to some embodiments;

FIG. 1C is a diagram of an example of an application scenario according to some embodiments;

FIG. 1D is a diagram of an example of an application scenario according to some embodiments;

FIG. 2 is a diagram of an example of an audio processing process according to some embodiments;

FIG. 3 is a diagram of an example of an audio processing process according to some embodiments;

FIG. 4 is a diagram of an example of an audio processing process according to some embodiments;

FIG. 5 is a diagram of an example of an audio processing process according to some embodiments;

FIG. 6A is a diagram of an example of frequency response curves of acoustic features according to some embodiments;

FIG. 6B is a diagram of an example of frequency response curves of acoustic features according to some embodiments;

FIG. 7 is a diagram of an example of an audio processing apparatus according to some embodiments; and

FIG. 8 is a diagram of an example of a structure of an apparatus according to some embodiments.

### DESCRIPTION OF EMBODIMENTS

The following clearly and completely describes technical solutions in embodiments of this application with reference to accompanying drawings in embodiments of this application. It is clear that the described embodiments are some but not all of embodiments of this application. All other embodiments obtained by a person of ordinary skill in the art based on embodiments of this application without creative efforts shall fall within the protection scope of this application.

The term “and/or” in this specification describes only an association relationship between associated objects and represents that three relationships may exist. For example, A and/or B may represent the following three cases: Only A exists, both A and B exist, and only B exists.

In the specification and claims in embodiments of this application, the terms “first”, “second”, and the like are intended to distinguish between different objects but do not indicate a particular order of the objects. For example, a first target object and a second target object are used to distinguish between different target objects, but are not used to describe a particular order of the target objects.

In embodiments of this application, the term “example”, “for example”, or the like is used to represent giving an example, an illustration, or a description. Any embodiment or design scheme described with “example” or “for example” in embodiments of this application should not be explained as being more preferred or having more advantages than another embodiment or design scheme. Exactly, use of the term “example”, “for example”, or the like is intended to present a relative concept in a specific manner.

In descriptions of embodiments of this application, unless otherwise specified, “a plurality of” means two or more than two. For example, a plurality of processing units mean two or more processing units, and a plurality of systems mean two or more systems.

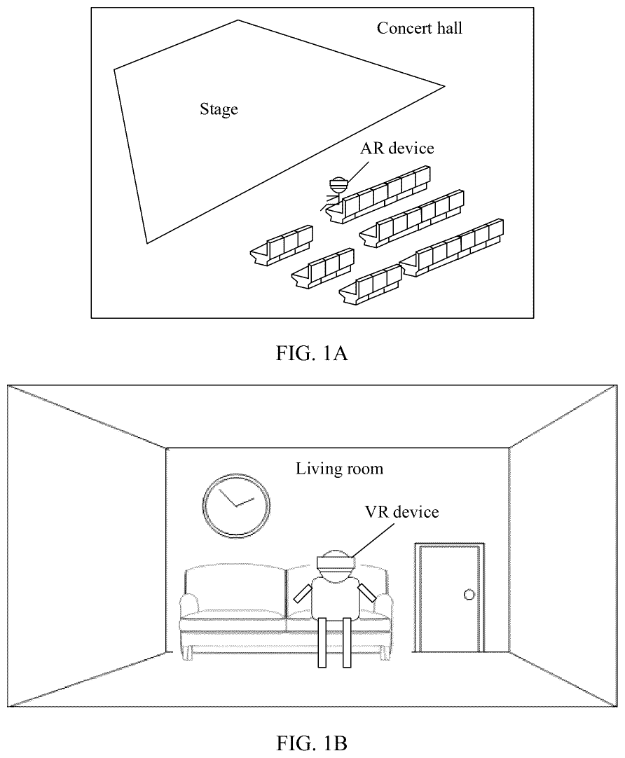

FIG. 1A is a diagram of an example of an application scenario. FIG. 1A shows an application scenario in which a user experiences an AR concert by using an AR device. It should be understood that the user may further use the AR device to experience another AR project, for example, an AR science lecture or an AR cinema. This is not limited in this application.

In FIG. 1A, a real scene in which the user is located and a virtual scene corresponding to the AR project experienced by the user are a same scene. To be specific, the real scene in which the user is located is a concert hall, and the virtual scene corresponding to the AR project experienced by the user is a virtual concert hall.

With reference to FIG. 1A, for example, when the user expects to experience the AR concert in an empty concert hall, the user may wear the AR device. Then, the user may select an AR concert hall from the AR device as an AR project that the user expects to experience, select a music file that the user expects to experience, and perform a play operation. Then, the AR device may process, for example, render, the music file selected by the user, to obtain a spatial audio signal, and play the spatial audio signal by using a headset. The AR device may further display a performance picture on a display, so that the user can see, on the display, that a performer performs at a corresponding position on a stage of the concert hall. In this way, the user can immerse himself or herself in the concert experience through combination of visual and auditory perception.

It should be understood that, in FIG. 1A, there may be one or more users in the concert hall experiencing an AR concert by using an AR device. This is not limited in this application.

FIG. 1B is a diagram of an example of an application scenario. FIG. 1B shows an application scenario in which a user experiences a VR cinema by using a VR device. It should be understood that the user may further use the VR device to experience another VR project, for example, a VR concert hall or a VR science lecture. This is not limited in this application.

In FIG. 1B, a real scene in which the user is located and a virtual scene corresponding to the VR project experienced by the user are not a same scene. To be specific, the real scene in which the user is located is a living room, and the virtual scene corresponding to the VR project experienced by the user is a virtual cinema.

With reference to FIG. 1B, for example, when the user expects to experience the VR cinema in the living room, the user may wear the VR device. Then, the user may select the VR cinema from the VR device as a VR project that the user expects to experience, select a movie file that the user expects to experience, and perform a play operation. Then, the VR device may process, for example, render, an audio file included in the movie file, to obtain a spatial audio signal, and play the spatial audio signal by using a headset. The VR device may further display a movie picture on a display. In this way, the user can immerse himself or herself in the movie experience through combination of visual and auditory perception.

FIG. 1C is a diagram of an example of an application scenario. FIG. 1C shows an application scenario in which a user experiences a concert by using a mobile phone and a headset.

It should be understood that the user may further use the mobile phone and the headset to experience another listening project, for example, crosstalk, a movie, or a live concert. This is not limited in this application. In addition, the mobile phone is merely an example of this application. In this application, the headset and a terminal device such as a tablet computer, a notebook computer, a personal computer, or a smartwatch may alternatively be used to experience listening.

In FIG. 1C, a real scene in which the user is located and a virtual scene corresponding to the listening project experienced by the user are a same scene. To be specific, the real scene in which the user is located is a concert hall, and the virtual scene corresponding to the listening project experienced by the user is a virtual concert hall.

With reference to FIG. 1C, for example, when the user expects to experience the concert in an empty concert hall, the user may wear the headset, and connect the headset to the mobile phone. Then, the user may select the concert from the mobile phone as a listening project that the user expects to experience, select a music file that the user expects to experience, and perform a play operation. Then, the mobile phone may process, for example, render, the music file selected by the user, to obtain a spatial audio signal. Then, the mobile phone may send the spatial audio signal to the headset for playing, and may further play a performance video picture of the concert. In this way, the user can experience the concert in the concert hall in an immersive manner by using the mobile phone.

It should be understood that, in FIG. 1C, there may be one or more users in the concert hall experiencing a concert by using a mobile phone. This is not limited in this application.

FIG. 1D is a diagram of an example of an application scenario. FIG. 1D shows an application scenario in which a user experiences crosstalk by using a mobile phone and a headset.

It should be understood that the user may further use the mobile phone and the headset to experience another listening project, for example, a concert, a movie, or a live concert. This is not limited in this application. In addition, the mobile phone is merely an example of this application. In this application, the headset and a terminal device such as a tablet computer, a notebook computer, a personal computer, or a smartwatch may alternatively be used for listening.

In FIG. 1D, a real scene in which the user is located and a virtual scene corresponding to the listening project experienced by the user are not a same scene. To be specific, the real scene in which the user is located is a bedroom, and the virtual scene corresponding to the listening project experienced by the user is a virtual studio.

With reference to FIG. 1D, for example, when the user expects to experience crosstalk in the bedroom, the user may wear the headset, and connect the headset to the mobile phone. Then, the user may select the crosstalk from the mobile phone as a listening project that the user expects to experience, select a crosstalk file that the user expects to experience, and perform a play operation. Then, the mobile phone may process, for example, render, the crosstalk file selected by the user, to obtain a spatial audio signal. Then, the mobile phone may send the spatial audio signal to the headset for playing, and may further play a crosstalk video picture. In this way, the user can experience the crosstalk in the bedroom in an immersive manner by using the mobile phone.

It should be understood that this application may be further applied to another listening scene or another virtual scene. This is not limited in this application.

The following describes a process of generating a spatial audio signal.

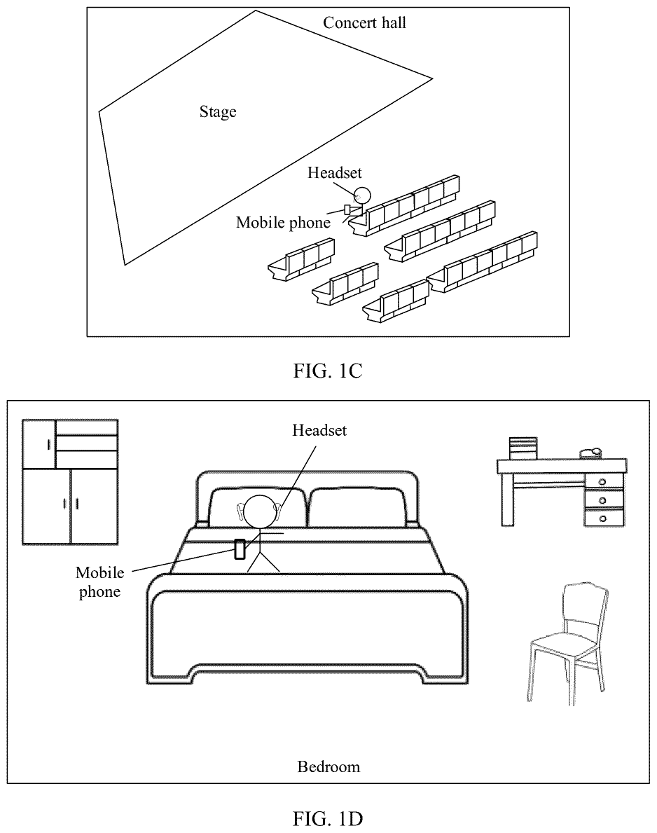

FIG. 2 is a diagram of an example of an audio processing process. Operations in the embodiment of FIG. 2 may be performed by a terminal device, for example, an AR device, a VR device, a mobile phone, a tablet computer, a notebook computer, a personal computer, or a smartwatch.

Operation S201: Obtain a source audio signal, a sound source position corresponding to the source audio signal in a virtual scene, and a first position corresponding to a user in the virtual scene, where the virtual scene is obtained through modeling based on a real scene.

For example, when the user needs to perform listening, the user may wear a headset and connect a mobile phone to the headset. Then, the user selects a listening project and an audio file that the user expects to experience from a terminal device, for example, the mobile phone, a tablet computer, a notebook computer, a personal computer, or a smartwatch, and performs a play operation. When the user needs to experience an AR/VR project, the user may wear an AR/VR device, then select the AR/VR project that the user expects to experience and a multimedia file that the user expects to experience, and then perform a play operation.

For example, after the user performs the play operation, the terminal device may obtain, in response to the user operation, the audio file selected by the user (or an audio file included in the multimedia file selected by the user), that is, obtain a source audio signal. The terminal device may further obtain a first position corresponding to the user in the virtual scene and a sound source position corresponding to the source audio signal in the virtual scene, to subsequently generate a spatial audio signal that matches the first position and the sound source position.

For example, the virtual scene in which the user is located in operation S201 may be a virtual scene corresponding to a listening project or AR/VR project selected (or experienced) by the user. For example, a listening project is a live concert, and a corresponding virtual scene is a virtual stadium or a virtual studio; a listening project is a movie, and a corresponding virtual scene is a virtual cinema; an AR/VR project is a concert, and a corresponding virtual scene is a virtual concert hall; and an AR/VR project is a lecture, and a corresponding virtual scene is a virtual lecture hall. In other words, the virtual scene in which the user is located in operation S201 may be a virtual scene corresponding to a spatial audio signal experienced by the user.

For example, the virtual scene is obtained through modeling based on the real scene, and the virtual scene may be generated in a plurality of manners. This is not limited in this application. Details are described below. The real scene is an objective scene, for example, a cinema, a concert hall, or a lecture hall. The virtual scene is a scene constructed by using a virtual technology, and is not an objective scene. The virtual scene corresponding to the listening project (or the AR/VR project) selected (or experienced) by the user is obtained through modeling based on the real scene. For example, a virtual concert hall is obtained through modeling based on a real concert hall. For another example, a virtual cinema is obtained through modeling based on a real cinema. For still another example, a virtual lecture hall is obtained through modeling based on a real lecture hall.

It should be noted that a real scene in which the user is currently located and the virtual scene corresponding to the listening project (or the AR/VR project) selected (or experienced) by the user may be a same scene, as shown in the embodiments of FIG. 1A and FIG. 1C, or may not be a same scene, as shown in the embodiments of FIG. 1B and FIG. 1D. This is not limited in this application. In other words, the real scene in which the user is currently located and the real scene used for modeling to obtain the virtual scene corresponding to the listening project (or the AR/VR project) selected (or experienced) by the user may be a same scene, as shown in the embodiments of FIG. 1A and FIG. 1C, or may not be a same scene, as shown in the embodiments of FIG. 1B and FIG. 1D. This is not limited in this application.

For example, when the real scene in which the user is currently located and the virtual scene corresponding to the listening project (or the AR/VR project) selected (or experienced) by the user are a same scene, a position of the user in the real scene is the same as a corresponding position of the user in the virtual scene, that is, the position of the user in the real scene is the first position.

For example, when the real scene in which the user is currently located and the virtual scene corresponding to the listening project (or the AR/VR project) selected (or experienced) by the user are not a same scene, in an embodiment, a default position may be determined as the first position corresponding to the user in the virtual scene. The default position may be set based on a requirement, for example, may be a position with optimal audio experience in the virtual scene. This is not limited in this application. In an embodiment, the terminal device may provide a position option in the virtual scene. In this way, before performing the play operation, the user may select a position option corresponding to a required experience position in the virtual scene. Further, the terminal device may use a position corresponding to the position option selected by the user as the first position corresponding to the user in the virtual scene.

Operation S202: Obtain a first acoustic feature, where the first acoustic feature is obtained by converting, based on an acoustic feature at a second position in the real scene and an acoustic feature at the second position in the virtual scene, an acoustic feature at the first position in the virtual scene when the source audio signal is at the sound source position.

Then, the first acoustic feature may be obtained, where the first acoustic feature may be used for spatial audio processing to generate the spatial audio signal.

For example, the first acoustic feature may be obtained by converting, based on the acoustic feature at the second position in the real scene and the acoustic feature at the second position in the virtual scene, the acoustic feature at the first position in the virtual scene when the source audio signal is at the sound source position in the virtual scene.

For example, the first acoustic feature includes but is not limited to an acoustic response, energy information, an acoustic parameter, or a derived acoustic feature. This is not limited in this application.

The acoustic response may include but is not limited to a room impulse response (RIR), a binaural room impulse response (BRIR), and a higher order ambisonics (HOA).

The energy information may include energy distribution, energy attenuation, and the like, corresponding to the acoustic response, across a plurality of frequency bands and a plurality of directions.

The acoustic parameter may include an environmental acoustic parameter and a binaural acoustic parameter. The environmental acoustic parameter includes but is not limited to a direct-to-reverberation energy ratio (DRR), reverberation time (Reverberation Time) (for example, T20 (time at which energy is attenuated by 20 dB), T30, or T60), a clarity (Clarity) (for example, C50 (a ratio of sound energy before and after 50 ms), or C80). The binaural acoustic parameter may include but is not limited to an interaural time difference (ITD), an interaural level difference (ILD), and an interaural cross correlation (IACC).

The derived acoustic feature may include a numerical analysis feature obtained by performing numerical analysis (for example, principal component analysis (PCA)) on the acoustic parameter, and may further include output information of an AI model (referred to as a first model below) obtained by inputting at least one of the acoustic response, the energy information, or the acoustic parameter into the first model.

For ease of subsequent description, the acoustic response included in the first acoustic feature may be referred to as a first acoustic response, the energy information included in the first acoustic feature may be referred to as first energy information, the acoustic parameter included in the first acoustic feature may be referred to as a first acoustic parameter, and the derived acoustic feature included in the first acoustic feature may be referred to as a first derived acoustic feature.

In a possible case, the first acoustic feature may be obtained by adjusting a second acoustic feature based on conversion information, where the second acoustic feature is obtained by performing acoustic feature extraction based on the first position, the virtual scene, and the sound source position, the conversion information is used to describe a conversion relationship between acoustic features at a same position in the virtual scene and the real scene, and the conversion information may be generated based on the acoustic feature at the second position in the real scene and the acoustic feature at the second position in the virtual scene.

In operation S202, in an embodiment, the conversion information may be first obtained, where the conversion information may be used to describe the conversion relationship between acoustic features at a same position in the virtual scene and the real scene. It should be noted that the conversion information may be generated in advance and stored in a database, or may be generated in real time. This is not limited in this application. A manner of generating the conversion information is described below. Then, the second acoustic feature is obtained, where the second acoustic feature is an acoustic feature at the first position in the virtual scene, and may be obtained by performing acoustic feature extraction based on the first position, the virtual scene, and the sound source position. Acoustic feature extraction manners may include but are not limited to acoustic simulation, machine learning, and numerical computation. This is not limited in this application. It should be noted that the second acoustic feature may be generated in advance and stored in a database, or may be generated in real time. This is not limited in this application. Then, the second acoustic feature may be adjusted based on the conversion information, to obtain the first acoustic feature. In this way, the acoustic feature at the first position in the virtual scene may be adjusted to be closer to an acoustic feature at the first position in the real scene, to improve quality and a sense of immersion of the spatial audio signal, thereby improving user experience. An acoustic feature at any position in the virtual scene may be referred to as a virtual acoustic feature, and an acoustic feature at any position in the real scene may be referred to as a real acoustic feature. In other words, the first acoustic feature and the second acoustic feature are virtual acoustic features.

In operation S202, in an embodiment, second preset acoustic features at each position (there are one or more second preset acoustic features at each position, and a plurality of second preset acoustic features at each position correspond to a plurality of virtual sound source positions) in various preset virtual scenes may be adjusted in advance based on each piece of preset conversion information (one piece of preset conversion information corresponds to one preset virtual scene), to obtain first preset acoustic features at each position in the various virtual scenes, and store the first preset acoustic features in a database. In this way, the first acoustic feature may be directly obtained from the database based on the virtual scene, the sound source position, and the first position.

It should be understood that the second acoustic feature may include but is not limited to a second acoustic response, second energy information, a second acoustic parameter, or a second derived acoustic feature.

It should be noted that the conversion information, the second acoustic feature, and the first acoustic feature may be stored in a same database, or may be stored in different databases. This is not limited in this application.

Operation S203: Generate the spatial audio signal based on the first acoustic feature and the source audio signal.

Then, spatial audio processing (for example, rendering) may be performed based on the first acoustic feature and the source audio signal, to obtain the spatial audio signal (for example, a binaural-rendered signal).

Then, the AR/VR device may play the spatial audio signal by using a built-in headset of the AR/VR device. The terminal device, for example, the mobile phone, the tablet computer, the notebook computer, or the smartwatch, may play the spatial audio signal by using a headset connected to the terminal device. In this way, the user can hear the spatial audio signal by using the headset.

The following describes a process of generating conversion information and a process of adjusting a second acoustic feature to obtain a first acoustic feature.

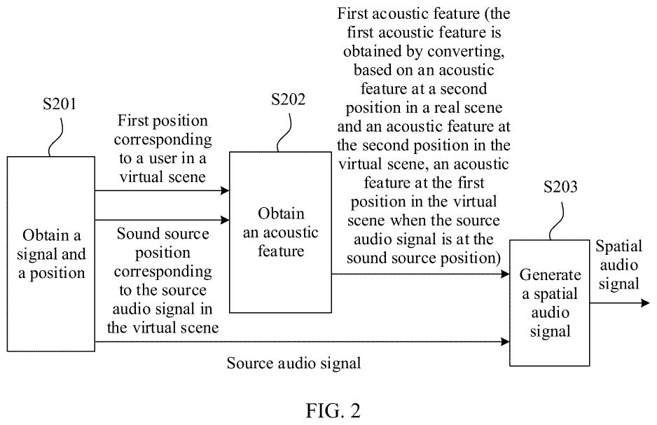

FIG. 3 is a diagram of an example of an audio processing process. In the embodiment of FIG. 3, a real scene in which a user is currently located and a virtual scene corresponding to a listening project (or an AR/VR project) selected (or experienced) by the user are a same scene (that is, an application scenario may be FIG. 1A or FIG. 1C). In this case, the conversion information, the second acoustic feature, and the first acoustic feature may all be generated in real time.

Operation S301: Construct the virtual scene based on the real scene.

In an embodiment, manual modeling may be performed. For example, information such as a size, a position, and a surface material of each object in the real scene may be input into modeling software, and the modeling software performs 3D modeling based on the input information of the user, to obtain the virtual scene.

In an embodiment, modeling may be performed based on visual information. For example, the user wears an AR/VR device, and captures, by moving or rotating the AR/VR device, an image sequence that can cover the real scene. Then, the AR/VR device performs 3D modeling based on the image sequence, to obtain the virtual scene.

It should be understood that the virtual scene may alternatively be constructed in another manner. This is not limited in this application.

It should be noted that operation S301 may be a operation performed in advance, or may be a operation performed in real time. This is not limited in this application.

Operation S302: Obtain a fourth acoustic feature at one or more second positions in the real scene.

In an embodiment, the fourth acoustic feature may be obtained by processing an audio signal received at the second position in the real scene.

For example, a sound source device may be deployed in the real scene. After the user moves to the second position with a receiving device, the sound source device may be controlled to play a test audio signal. Correspondingly, the receiving device at the second position may receive the test audio signal. Then, the receiving device may process the received test audio signal to obtain the fourth acoustic feature. It should be understood that the fourth acoustic feature is a real acoustic feature.

For example, the sound source device plays a test audio signal such as a pulse signal, a noise signal, or a sweep signal, and the receiving device at the second position receives and processes the test audio signal, to obtain an acoustic response in a format such as an RIR, a BRIR, or an HOA.

For another example, the sound source device plays a sound signal such as a pulse signal, a noise signal, or a sweep signal, and the receiving device at the second position receives and processes the test audio signal, to obtain energy information, an acoustic parameter, a derived acoustic feature, and the like.

For another example, the sound source device plays a natural audio signal (such as a voice, a song, pure music, or a video), and the receiving device at the second position receives and processes the test audio signal, to obtain an acoustic response in a format such as an RIR, a BRIR, or an HOA.

For another example, the sound source device plays a natural audio signal (such as a voice, a song, pure music, or a video), and the receiving device at the second position receives and processes the test audio signal, to obtain energy information, an acoustic parameter, a derived acoustic feature, and the like.

The sound source device includes but is not limited to a speaker device (for example, a home audio system), a terminal device (for example, a tablet computer or a large screen) with an external play function, and a professional acoustic measurement device.

The receiving device includes but is not limited to a terminal device (for example, a tablet computer, a mobile phone, or an AR/VR device) including a microphone and a professional acoustic measurement device.

There are one or more second positions. For example, when the real scene is a uniform room (for example, a square room with consistent wall materials, where the room may be understood as an indoor scene), and a difference between real acoustic features at different positions is small, there may be one second position, so that workload can be reduced. For another example, when the real scene is a non-uniform room (for example, an asymmetric room with diversified wall materials), and a difference between real acoustic features at different positions is large, there may be a plurality of second positions, so that accuracy of generated conversion information can be improved. It should be understood that a quantity of second positions may be determined based on a requirement. This is not limited in this application.

In an embodiment, when the terminal device is an AR/VR device, the AR/VR device may display a measurement instruction on a display, where the measurement instruction may include the second position. In this way, the user may wear the AR/VR device and move according to the second position displayed on the display of the AR/VR device. In a movement process of the user, the AR/VR device may perform positioning in real time to obtain position information, and perform movement prompting based on the obtained position information. When determining, based on the obtained position information, that the user moves to the second position, the AR/VR device may prompt the user to stop moving. After the AR/VR device receives a test audio signal and obtains a fourth acoustic feature through processing at one second position, the AR/VR device may play test success information. When there are a plurality of second positions, the AR/VR device may prompt the user to move to a next second position until the AR/VR device obtains fourth acoustic features at all second positions in the real scene. When the AR/VR device does not receive a test audio signal or does not obtain a fourth acoustic feature at a second position, the AR/VR device may play test failure information, and prompt the user to perform a test again, that is, prompt the user to still stay at the current second position to receive a test audio signal. In this case, the AR/VR device may record position information of one or more second positions, to subsequently determine a third acoustic feature at the one or more second positions in the virtual scene.

In an embodiment, when the terminal device is an AR/VR device, the AR/VR device may display a measurement instruction on a display, where the measurement instruction may include a quantity of second positions. In this way, the user may first select, based on the quantity of second positions displayed on the display, a corresponding quantity of second positions in the AR/VR device in a defined manner, and then wear the AR/VR device to move to the second position selected in the defined manner. In a movement process of the user, the AR/VR device may perform positioning in real time to obtain position information, and perform movement prompting based on the obtained position information. When determining, based on the obtained position information, that the user moves to the second position, the AR/VR device may prompt the user to stop moving. After the AR/VR device receives a test audio signal and obtains a fourth acoustic feature through processing at one second position, the AR/VR device may play test success information. When there are a plurality of second positions, the AR/VR device may prompt the user to move to a next second position until the AR/VR device obtains fourth acoustic features at all second positions in the real scene. When the AR/VR device does not receive a test audio signal or does not obtain a fourth acoustic feature at a second position, the AR/VR device may play test failure information, and prompt the user to perform a test again, that is, prompt the user to still stay at the current second position to receive a test audio signal. In this case, the AR/VR device may record position information of one or more second positions, to subsequently determine a third acoustic feature at the one or more second positions in the virtual scene.

In an embodiment, when the terminal device is a terminal device with low positioning precision, for example, a tablet computer, a notebook computer, or a mobile phone, the virtual scene may be displayed on the terminal device, and the second position is identified in the virtual scene. In this way, the user carries the terminal device, moves to the second position identified by the terminal device in the virtual scene, and then stops. Then, the user performs a recording operation on the terminal device. In this case, the terminal device may receive a test audio signal at the second position. After the terminal device receives the test audio signal and obtains a fourth acoustic feature through processing at the second position, the terminal device may play test success information. When there are a plurality of second positions, the terminal device may prompt the user to move to a next second position until the terminal device obtains fourth acoustic features at all second positions in the real scene. When the terminal device does not receive a test audio signal or does not obtain a fourth acoustic feature at the second position, the terminal device may play test failure information, and prompt the user to perform a test again, that is, prompt the user to still stay at the current second position to receive a test audio signal. In this case, the user may input position information (for example, a distance from a wall, a direction of an object relative to the user, and a height of the user) of one or more second positions in the terminal device, to subsequently determine a third acoustic feature at the one or more second positions in the virtual scene.

It should be understood that the fourth acoustic feature may include but is not limited to a fourth acoustic response, fourth energy information, a fourth acoustic parameter, or a fourth derived acoustic feature.

In addition, position information of the sound source device in the real scene may be further recorded, to subsequently determine the third acoustic feature at the one or more second positions in the virtual scene.

In an embodiment, the fourth acoustic feature is input by the user in a defined manner.

In some real scenes, acoustic features obtained through actual measurement may not necessarily be closest to acoustic features that match actual auditory perception of the user. Therefore, the acoustic features that match the actual auditory perception of the user in the real scenes are directly input, so that adjusted acoustic features are closer to the acoustic features that match the actual auditory perception of the user in the real scenes. In this way, spatial audio signals subsequently generated based on the adjusted acoustic features are closer to spatial audio signals heard by the user in the real scenes corresponding to some virtual scenes.

For example, “some real scenes” may include:
1. Real scene in which there is inevitable interference noise. For example, there is inevitable interference noise in the real scene or nearby the real scene (for example, a next room is under construction). A fourth acoustic feature to be input by the user in the defined manner may be determined based on a design parameter, historical related data, and the like of the real scene.
2. Real scene in which visual presentation of a surface material is inconsistent with actual acoustic effect of the surface material. For this real scene, if a fourth acoustic feature is obtained by processing a test audio signal received at a second position in the real scene, when a spatial audio signal is subsequently generated and played, auditory perception of the user may not match visual perception of the user.
3. Real scene used as multi-functional space. In other words, the real scene is used as the multi-functional space. For example, a real scene is used as a lecture hall, a concert hall, and a movie and television hall. Because the user has different auditory perception requirements for spatial audio signals in different virtual scenes, virtual acoustic features in the different virtual scenes are different. If real acoustic features are obtained through measurement in a same real scene for different virtual scenes, when spatial audio signals are subsequently generated and played, the auditory perception of the user may not match the visual perception of the user.

It should be noted that, in an embodiment, a sound source device may be deployed at one position (referred to as a preset sound source position below). In this way, one fourth acoustic feature may be correspondingly obtained at one second position. In an embodiment, sound source devices may be deployed at a plurality of preset sound source positions. In this way, a plurality of fourth acoustic features may be correspondingly obtained at one second position.

Operation S303: Obtain the third acoustic feature at the one or more second positions in the virtual scene.

Correspondingly, acoustic feature extraction may be performed based on the position information of the sound source device recorded in operation S302, the position information of the second position recorded in operation S302, the test audio signal played by the sound source device in operation S302, and the virtual scene, to determine the third acoustic feature at the one or more second positions. Similarly, one or more third acoustic features may be correspondingly obtained at one second position. It should be understood that the third acoustic feature is a virtual acoustic feature.

It should be understood that the third acoustic feature may include but is not limited to a third acoustic response, third energy information, a third acoustic parameter, or a third derived acoustic feature.

In this way, after operations S302 and S303 are performed, one or more acoustic feature groups may be obtained for one second position. One acoustic feature group includes one third acoustic feature and one fourth acoustic feature. A third acoustic feature and a fourth acoustic feature that belong to a same acoustic feature group correspond to a same second position and a same preset sound source position.

Operation S304: Analyze a third acoustic feature and a fourth acoustic feature in one or more acoustic feature groups to obtain the conversion information.

For example, in this application, the third acoustic feature and the fourth acoustic feature in the one or more acoustic feature groups may be analyzed and compared in a manner such as signal processing, machine learning, or numerical analysis, to obtain the conversion information.

The following uses one acoustic feature group as an example to describe a method for generating conversion information.

In an embodiment, signal processing may be separately performed on a third acoustic feature and a fourth acoustic feature in one acoustic feature group, to obtain signal processing results. Then, a signal processing result of the third acoustic feature and a signal processing result of the fourth acoustic feature are analyzed, to obtain a conversion function. In this case, the conversion function may be used as conversion information. For example, for a third acoustic response, for example, an RIR, included in the third acoustic feature and a fourth acoustic response, for example, an RIR, included in the fourth acoustic feature, where the RIR in the third acoustic response is represented by an RIR 1, and the RIR in the fourth acoustic response is represented by an RIR 2, frequency domain conversion may be separately performed on the RIR 1 and the RIR 2, to obtain a frequency domain response (referred to as a frequency response 1) of the RIR 1 and a frequency domain response (referred to as a frequency response 2) of the RIR 2. Then, in an embodiment, a frequency response conversion function may be calculated by using the frequency response 1 and the frequency response 2, and the frequency response conversion function is used as the conversion function; and in an embodiment, signal analysis may be separately performed on the frequency response 1 and the frequency response 2, and then the conversion function is determined based on signal analysis results.

In an embodiment, numerical analysis may be separately performed on a third acoustic feature and a fourth acoustic feature in one acoustic feature group, to obtain a feature change rate. In this case, the feature change rate may be used as conversion information. Specifically, a change rate of the third acoustic feature in the acoustic feature group relative to the fourth acoustic feature in the acoustic feature group may be calculated as the feature change rate. For example, for a third acoustic parameter, for example, a direct-to-reverberation energy ratio, included in the third acoustic feature and a fourth acoustic parameter, for example, a direct-to-reverberation energy ratio, included in the fourth acoustic feature, where the direct-to-reverberation energy ratio in the third acoustic parameter is represented by a DRR 1, and the direct-to-reverberation energy ratio in the fourth acoustic parameter is represented by a DRR 2, a corresponding feature change rate may be (DRR 1-DRR 2)/DRR 2 or DRR 1/DRR 2. It should be understood that the conversion information may include a plurality of feature change rates (the plurality of feature change rates are in a one-to-one correspondence with a plurality of acoustic parameters). This is not limited in this application.

In an embodiment, a third acoustic feature and a fourth acoustic feature in one acoustic feature group may be processed in a machine learning manner, to obtain conversion information. Specifically, a third acoustic feature and a fourth acoustic feature in one acoustic feature group may be input to an AI model (or referred to as a machine learning model, which is referred to as a second model below), and the second model processes the third acoustic feature and the fourth acoustic feature in the acoustic feature group to output conversion information. In other words, model output information of the second model is the conversion information.

It should be understood that the conversion information may alternatively be generated in another manner. This is not limited in this application.

Operation S305: Obtain a source audio signal, a sound source position corresponding to the source audio signal in the virtual scene, and a first position corresponding to the user in the virtual scene.

For example, for operation S305, reference may be made to the descriptions of operation S201. Details are not described herein again.

Operation S306: Perform acoustic feature extraction based on the first position, the sound source position of the source audio signal, and the virtual scene, to obtain the second acoustic feature.

For example, the second acoustic feature may be understood as a virtual acoustic feature at the first position in the virtual scene when a virtual sound source at the sound source position plays the source audio signal.

Operation S307: Adjust the second acoustic feature based on the conversion information, to obtain the first acoustic feature.

For example, the second acoustic feature may be adjusted based on the conversion information, to obtain the first acoustic feature. In this way, when the virtual sound source at the sound source position in the virtual scene plays the source audio signal, a virtual acoustic feature at the first position may be adjusted to be close to or consistent with a real acoustic feature at the first position when a real sound source at the sound source position in the real scene plays the source audio signal.

For example, for different types of second acoustic features, different adjustment methods may be used. For example, when the second acoustic feature is a second acoustic response, a frequency response curve adjustment algorithm based on signal processing may be used. Specifically, frequency domain conversion may be performed on the second acoustic response, to obtain a frequency domain response (referred to as a frequency response 3 below) of the second acoustic response. Then, the frequency response 3 may be adjusted according to the determined conversion function, to obtain an adjusted frequency response 3. Then, the adjusted frequency response 3 is converted into a first acoustic response, that is, the first acoustic feature.

For another example, when the second acoustic feature includes a second acoustic response and a second acoustic parameter, a reverberation adjustment algorithm based on signal processing may be used. Specifically, for a second DRR in the second acoustic parameter, the second DRR may be adjusted based on the calculated change rate of the direct-to-reverberation energy ratio, to obtain a first DRR (that is, a first acoustic parameter included in the first acoustic feature). Then, the second acoustic response may be adjusted based on the first DRR, to obtain a first acoustic response. It should be understood that another second acoustic parameter may also be adjusted based on a corresponding feature change rate. This is not limited in this application.

For still another example, an adjustment algorithm is an adjustment algorithm based on an AI model. Specifically, the second acoustic feature and the conversion information may be input into an AI model (referred to as a third model below), and the third model adjusts the second acoustic feature based on the conversion information, to output the first acoustic feature.

It should be understood that the second acoustic feature may be further adjusted by using another adjustment algorithm, to obtain the first acoustic feature. This is not limited in this application.

It should be noted that, the conversion information obtained in operation S304 may be used to adjust a second acoustic feature at any first position in the virtual environment, to obtain the first acoustic feature. In other words, in operation S304, only the third acoustic feature and the fourth acoustic feature at the one or more second positions need to be analyzed, and the obtained conversion information has universality at any position in a same room (that is, the virtual scene), and is not only used to adjust an acoustic feature at a first position close to the second position.

Operation S308: Generate a spatial audio signal based on the first acoustic feature and the source audio signal.

For example, when the first acoustic feature is the first acoustic response, the first acoustic response may be convolved with the source audio signal, to obtain the spatial audio signal.

For example, when the first acoustic feature includes the first acoustic response and first energy information, energy of a spatial audio signal may be adjusted based on the first energy information. Then, an adjusted first acoustic response is convolved with the source audio, to obtain the spatial audio signal.

For example, when the first acoustic feature includes the first acoustic parameter and a first derived acoustic feature, the first acoustic response may be generated based on the first acoustic parameter and the first acoustic feature. Then, the first acoustic response may be convolved with the source audio, to obtain the spatial audio signal.

For example, when the first acoustic feature includes the first acoustic response, the first acoustic parameter, and a first derived acoustic feature, the first acoustic response may be first optimized based on the first acoustic parameter and the first acoustic feature. Then, an optimized first acoustic response is convolved with the source audio, to obtain the spatial audio signal.

It should be understood that there are a plurality of manners of generating the spatial audio signal based on the first acoustic feature. This is not limited in this application.

In an embodiment, preset conversion information corresponding to a plurality of preset virtual scenes may be generated in advance and stored in a database, and second preset acoustic features at a plurality of positions in the plurality of preset virtual scenes may be generated in advance and stored in a database. In this way, in an application process, conversion information corresponding to a current virtual scene may be read from the database, and a first position in the current virtual scene is determined in real time in the application process, so that a second acoustic feature that matches the first position and a sound source position in the current virtual scene is read from the database, and the second acoustic feature is adjusted in real time, to obtain a first acoustic feature that matches the first position and the sound source position in the current virtual scene. Through use of the database, time for generating a spatial audio signal can be shortened, and user experience can be improved. In addition, a virtual scene that may be used for a plurality of times at different time, by different users, or in different applications may alternatively be invoked in a more efficient manner.

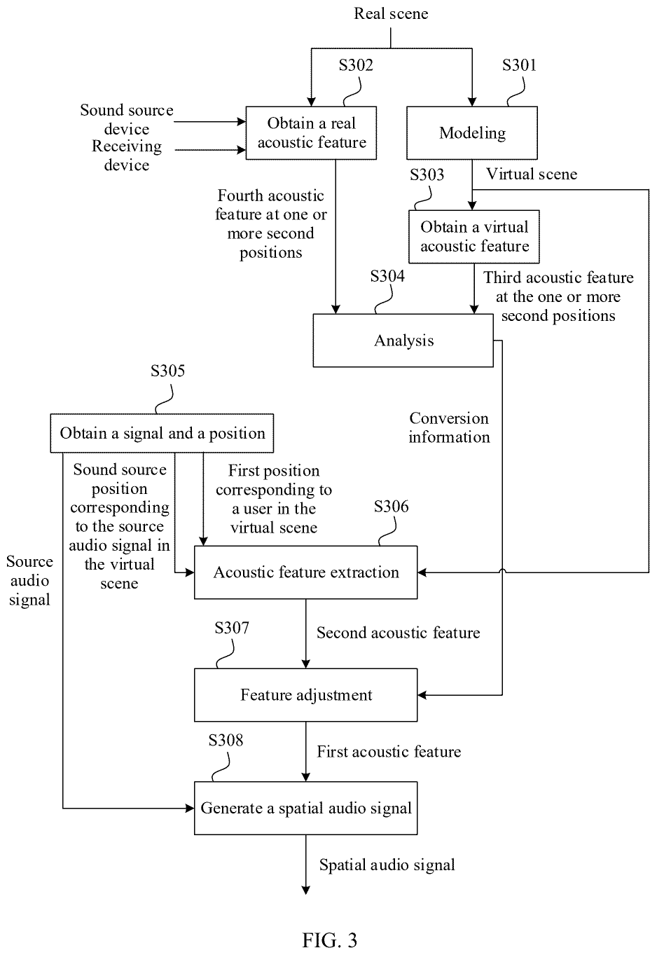

FIG. 4 is a diagram of an example of an audio processing process. In the embodiment of FIG. 4, whether a real scene in which a user is currently located and a virtual scene corresponding to a listening project (or an AR/VR project) selected (or experienced) by the user are a same scene is not limited. In other words, an application scenario of the embodiment of FIG. 4 may be FIG. 1A to FIG. 1D.

Operation S401: Obtain a source audio signal, a sound source position corresponding to the source audio signal in the virtual scene, and a first position corresponding to the user in the virtual scene.

Operation S402: Select, from a plurality of second acoustic feature sets stored in a database, a second acoustic feature set corresponding to the virtual scene.

Operation S403: Select, based on the sound source position of the source audio signal and the first position, a second acoustic feature from the second acoustic feature set corresponding to the virtual scene.

For example, a plurality of second acoustic feature sets may be generated in advance for a plurality of preset virtual scenes, where the plurality of second acoustic feature sets are in a one-to-one correspondence with the plurality of preset virtual scenes.

Specifically, for one preset virtual scene, a plurality of positions (referred to as fourth positions below) may be identified in the preset virtual scene in advance. For example, the preset virtual scene is divided into a 10*10 grid, and an intersection point of grid lines or a center point of a cell may be used as the fourth position. Then, for each fourth position, acoustic feature extraction may be performed based on the fourth position, a preset sound source position in the preset virtual scene, and the preset virtual scene, to obtain a second preset acoustic feature at the fourth position. There may be a plurality of preset sound source positions in the preset virtual scene. In this way, for one fourth position, a plurality of second preset acoustic features may be obtained. In this manner, second preset acoustic features at the plurality of fourth positions may be obtained, and the second preset acoustic features at the plurality of fourth positions may form a second acoustic feature set corresponding to the preset virtual scene. Then, the second acoustic feature set may be stored in the database, and a correspondence between the second acoustic feature set and the preset virtual scene is established.

In the foregoing manner, the plurality of second acoustic feature sets may be generated; and the plurality of second acoustic feature sets may be stored in the database, and a correspondence between the plurality of second acoustic feature sets and the corresponding preset virtual scenes is established.

For example, the second acoustic feature set corresponding to the current virtual scene may be first filtered out from the database. Then, based on the sound source position of the source audio signal and the fourth position, a second preset acoustic feature whose preset sound source position is the same as or closest to the sound source position and whose fourth position is the same as or closest to the first position is selected from the obtained second acoustic feature set as the second acoustic feature.

Operation S404: Select, based on the virtual scene, conversion information from a plurality of pieces of preset conversion information stored in a database, where the plurality of pieces of preset conversion information are in a one-to-one correspondence with the plurality of preset virtual scenes.

For example, for one preset virtual scene in the plurality of preset virtual scenes, preset conversion information may be generated in advance according to the descriptions in operations S302 to S304, the preset conversion information is stored in the database, and a correspondence between the preset conversion information and the preset virtual scene is established. In a process of performing operation S404, preset conversion information whose corresponding preset virtual scene is the same as the current virtual scene may be selected from the database as the conversion information corresponding to the current virtual scene.

Operation S405: Adjust the second acoustic feature based on the conversion information, to obtain a first acoustic feature.

Operation S406: Generate a spatial audio signal based on the first acoustic feature and the source audio signal.

For operations S405 and S406, refer to the descriptions of operations S307 and S308. Details are not described herein again.

In an embodiment, first acoustic features at a plurality of positions in a plurality of preset virtual scenes may be generated in advance and stored in a database. In this way, in an application process, a first acoustic feature that matches a first position and a sound source position in a current virtual scene may be read from the database, so that time for generating a spatial audio signal can be further shortened, and user experience can be improved. In addition, a virtual scene that may be used for a plurality of times at different time, by different users, or in different applications may alternatively be invoked in a more efficient manner.

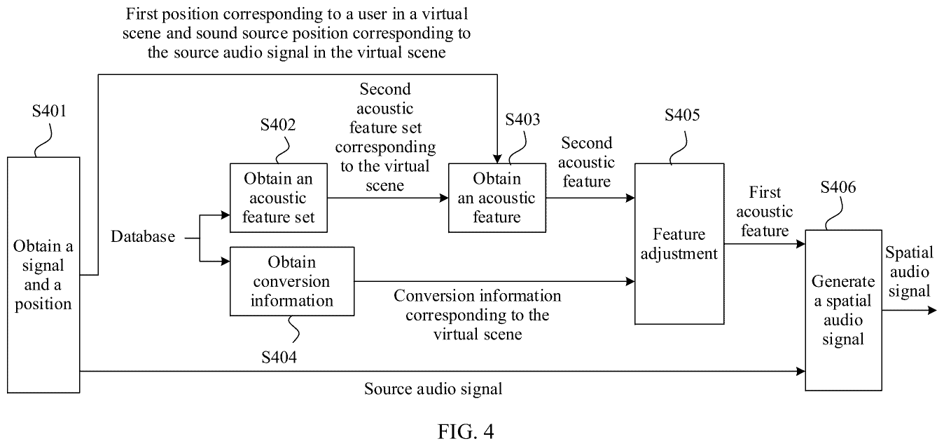

FIG. 5 is a diagram of an example of an audio processing process. In the embodiment of FIG. 5, whether a real scene in which a user is currently located and a virtual scene corresponding to a listening project (or an AR/VR project) selected (or experienced) by the user are a same scene is not limited. In other words, an application scenario of the embodiment of FIG. 5 may be FIG. 1A to FIG. 1D.

Operation S501: Obtain a source audio signal, a sound source position of the source audio signal in the virtual scene, and a first position corresponding to the user in the virtual scene.

Operation S502: Select, from a plurality of first acoustic feature sets stored in a database, a first acoustic feature set corresponding to the virtual scene.

Operation S503: Select, based on the sound source position of the source audio signal and the first position, a first acoustic feature from the first acoustic feature set corresponding to the virtual scene.

For example, for one preset virtual scene in a plurality of preset virtual scenes, corresponding conversion information is generated in advance according to the embodiment of FIG. 3, and a corresponding second acoustic feature set is generated in advance according to the embodiment of FIG. 4. Then, second preset acoustic features at a plurality of positions (referred to as third positions below) in the second acoustic feature set corresponding to the preset virtual scene may be adjusted based on the conversion information corresponding to the preset virtual scene, to obtain first preset acoustic features at the plurality of third positions. The first preset acoustic features at the plurality of third positions may form a first acoustic feature set, that is, a first acoustic feature set corresponding to the preset virtual scene. Then, the first acoustic feature set corresponding to the preset virtual scene may be stored in the database, and a correspondence between the first acoustic feature set and the preset virtual scene is established.

It should be understood that there may be a plurality of preset sound source positions in the preset virtual scene. In this way, for one third position, a plurality of second preset acoustic features may be obtained. Correspondingly, for one third position, a plurality of first preset acoustic features may be obtained, and each first preset acoustic feature corresponds to one preset acoustic position.

For example, the first acoustic feature set corresponding to the current virtual scene may be first filtered out from the database. Then, a first preset acoustic feature whose preset sound source position is the same as or closest to the sound source position and whose third position is the same as or closest to the first position is selected from the obtained first acoustic feature set as the first acoustic feature.

Operation S504: Generate a spatial audio signal based on the first acoustic feature and the source audio signal.

For operation S504, refer to the descriptions of operation S308. Details are not described herein again.

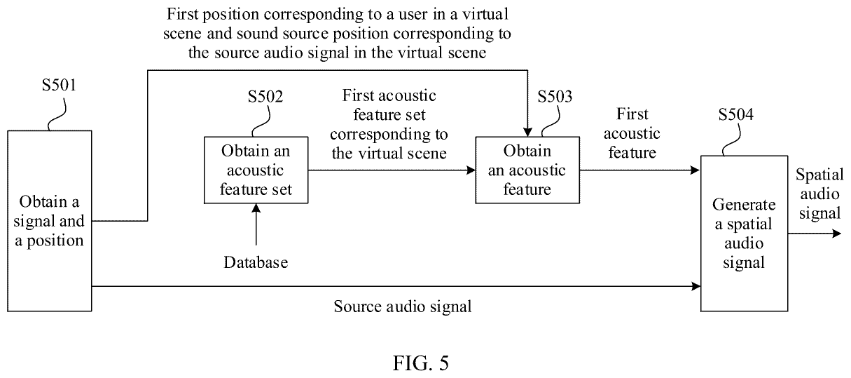

FIG. 6A and FIG. 6B are diagrams of examples of frequency response curves of acoustic features. FIG. 6A and FIG. 6B show a frequency response curve (for example, a curve 1) of a real acoustic feature, a frequency response curve (for example, a curve 2) of an adjusted virtual acoustic feature (namely, a first acoustic feature), and a frequency response curve (for example, a curve 3) of an unadjusted virtual acoustic feature (namely, a second acoustic feature) when a user is at different first positions in a virtual scene. It can be learned from comparison between the curve 1, the curve 2, and the curve 3 that the frequency response curve of the adjusted virtual acoustic feature is closer to the frequency response curve of the real acoustic feature. In other words, according to the method provided in this application, the virtual acoustic feature can be closer to the real acoustic feature, thereby improving quality of a spatial audio signal.

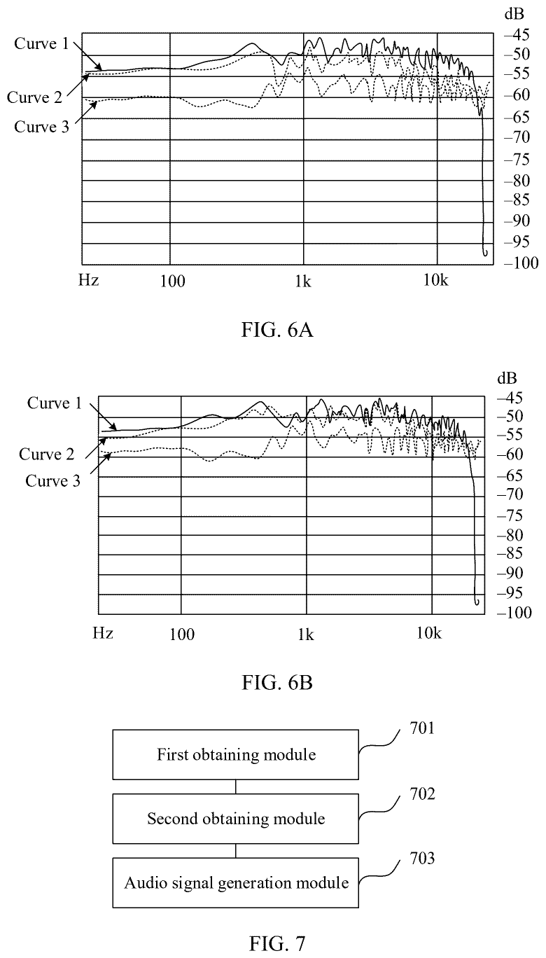

FIG. 7 is a diagram of an example of an audio processing apparatus.

A first obtaining module 701 is configured to obtain a source audio signal, a sound source position of the source audio signal in a virtual scene, and a first position corresponding to a user in the virtual scene, where the virtual scene is obtained through modeling based on a real scene.

A second obtaining module 702 is configured to obtain a first acoustic feature based on the sound source position and the first position, where the first acoustic feature is obtained by adjusting a second acoustic feature based on conversion information, the second acoustic feature is obtained by performing acoustic feature extraction based on the first position, the virtual scene, and the sound source position, and the conversion information is used to describe a conversion relationship between acoustic features at a same position in the virtual scene and the real scene.

An audio signal generation module 703 is configured to generate a spatial audio signal based on the first acoustic feature and the source audio signal.

For example, the conversion information is determined by analyzing an acoustic feature group, the acoustic feature group includes a third acoustic feature and a fourth acoustic feature, the fourth acoustic feature is an acoustic feature at a second position in the real scene, and the third acoustic feature is an acoustic feature at the second position in the virtual scene.

For example, there are one or more acoustic feature groups, there are one or more second positions, and a third acoustic feature and a fourth acoustic feature that belong to a same acoustic feature group correspond to a same second position.

For example, the conversion information includes a conversion function, and the conversion function is obtained by analyzing signal processing results of the third acoustic feature and the fourth acoustic feature.

For example, the conversion information includes a feature change rate, and the feature change rate is a change rate of the third acoustic feature relative to the fourth acoustic feature.

For example, the conversion information includes model output information obtained after the third acoustic feature and the fourth acoustic feature are input into a model.

For example, the first acoustic feature includes at least one of the following: an acoustic response, energy information, an acoustic parameter, or a derived acoustic feature.

For example, the fourth acoustic feature is obtained by processing a test audio signal received at the second position in the real scene.

For example, the fourth acoustic feature is input by the user in a defined manner.

For example, the second obtaining module 702 is specifically configured to: determine one or more acoustic feature groups, where one acoustic feature group includes a third acoustic feature and a fourth acoustic feature, the fourth acoustic feature is an acoustic feature at a second position in the real scene, and the third acoustic feature is an acoustic feature at the second position in the virtual scene; analyze a third acoustic feature and a fourth acoustic feature in the one or more acoustic feature groups to obtain conversion information; perform acoustic feature extraction based on the first position, the virtual scene, and the sound source position, to obtain a second acoustic feature; and adjust the second acoustic feature based on the conversion information, to obtain the first acoustic feature.

For example, the second obtaining module 702 is specifically configured to: select, from a plurality of second acoustic feature sets stored in a database, a second acoustic feature set corresponding to the virtual scene, where the plurality of second acoustic feature sets are in a one-to-one correspondence with a plurality of preset virtual scenes, one second acoustic feature set includes a plurality of second preset acoustic features, one second acoustic feature set is obtained by performing acoustic feature extraction based on one preset virtual scene, a plurality of fourth positions, and a plurality of preset sound source positions, and one fourth position and one preset sound source position are used to determine one second preset acoustic feature in one second acoustic feature set; select, based on the sound source position and the first position, a second acoustic feature from the second acoustic feature set corresponding to the virtual scene; select, based on the virtual scene, conversion information from a plurality of pieces of preset conversion information stored in a database, where the plurality of pieces of preset conversion information are in a one-to-one correspondence with the plurality of preset virtual scenes; and adjust the second acoustic feature based on the conversion information, to obtain the first acoustic feature.

For example, that the second obtaining module 702 is specifically configured to obtain the first acoustic feature includes:
selecting, from a plurality of first acoustic feature sets stored in a database, a first acoustic feature set corresponding to the virtual scene, where the plurality of first acoustic feature sets are in a one-to-one correspondence with a plurality of preset virtual scenes, the plurality of first acoustic feature sets are in a one-to-one correspondence with a plurality of second acoustic feature sets, one second acoustic feature set is obtained by performing acoustic feature extraction based on one preset virtual scene, a plurality of third positions, and a plurality of preset sound source positions, one third position and one preset sound source position are used to determine one second preset acoustic feature in one second acoustic feature set, and one first preset acoustic feature in one first acoustic feature set is obtained by adjusting one second preset acoustic feature in a corresponding second acoustic feature set based on conversion information; and selecting, based on the sound source position and the first position, the first acoustic feature from the first acoustic feature set corresponding to the virtual scene.

An embodiment of this application further provides an AR device. The AR device includes a display module, an image capture module, a headset, and a processor. The processor is configured to perform the audio processing method in the foregoing embodiments. The headset is configured to play the spatial audio signal generated by using the audio processing method in the foregoing embodiments.

An embodiment of this application further provides a VR device. The VR device includes a display module, an image capture module, a headset, and a processor. The processor is configured to perform the audio processing method in the foregoing embodiments. The headset is configured to play the spatial audio signal generated by using the audio processing method in the foregoing embodiments.

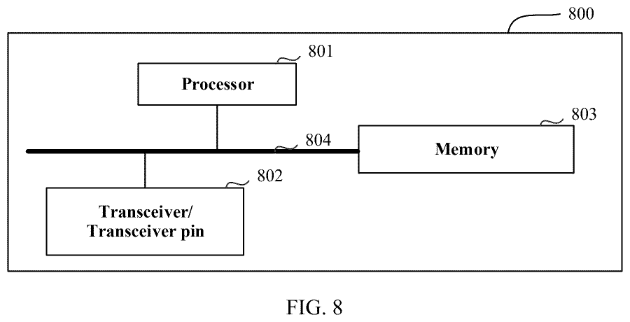

In an example, FIG. 8 is a block diagram of an apparatus 800 according to an embodiment of this application. The apparatus 800 may include a processor 801 and a transceiver/transceiver pin 802. In an embodiment, the apparatus 800 further includes a memory 803.

Components of the apparatus 800 are coupled together through a bus 804. In addition to a data bus, the bus 804 further includes a power bus, a control bus, and a status signal bus. However, for clear description, various types of buses in the figure are referred to as the bus 804.

In an embodiment, the memory 803 may be configured to store instructions in the foregoing method embodiments. The processor 801 may be configured to: execute the instructions in the memory 803, control a receiving pin to receive a signal, and control a sending pin to send a signal.

The apparatus 800 may be the electronic device in the method embodiments or a chip of the electronic device.

All related content of the operations in the method embodiments may be cited in function descriptions of the corresponding functional modules. Details are not described herein again.

An embodiment of this application further provides a chip. The chip includes one or more interface circuits and one or more processors. The one or more processors receive or send data through the one or more interface circuits. When the one or more processors execute computer instructions, the foregoing related method operations for implementing the operations of method in the foregoing embodiments are performed. The interface circuit is the transceiver/transceiver pin 802.

An embodiment further provides a computer-readable storage medium. The computer-readable storage medium stores computer instructions. When the computer instructions are run on an electronic device, the electronic device is enabled to perform the foregoing related method operations, to implement the method in the foregoing embodiments.

An embodiment further provides a computer program product. The computer program product includes computer instructions. When the computer instructions are executed by a computer or a processor, the computer is enabled to perform the foregoing related operations, to implement the method in the foregoing embodiments.

In addition, an embodiment of this application further provides an apparatus. The apparatus may be specifically a chip, a component, or a module. The apparatus may include a processor and a memory that are connected to each other. The memory is configured to store computer-executable instructions. When the apparatus runs, the processor may execute the computer-executable instructions stored in the memory, to enable the chip to perform the method in the foregoing method embodiments.

The electronic device, the computer-readable storage medium, the computer program product, or the chip provided in embodiments is configured to perform the corresponding method provided above. Therefore, for beneficial effect that can be achieved, refer to the beneficial effect in the corresponding method provided above. Details are not described herein.

Based on the descriptions about the foregoing implementations, a person skilled in the art may understand that, for the purpose of convenient and brief description, division into the functional modules is used as an example for description. During actual application, the foregoing functions may be allocated to different functional modules based on a requirement for implementation. In other words, an inner structure of an apparatus is divided into different functional modules to implement all or some of the functions described above.

In several embodiments provided in this application, it should be understood that the disclosed apparatuses and methods may be implemented in other manners. For example, the described apparatus embodiments are merely examples. For example, division into the modules or units is merely logical function division and may be other division during actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

Units described as separate parts may or may not be physically separate, and parts displayed as units may be one or more physical units, that is, may be located in one place, or may be distributed to different places. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit. The integrated unit may be implemented in a form of hardware, or may be implemented in a form of a software functional unit.

Any content in embodiments of this application and any content in a same embodiment can be freely combined. Any combination of the foregoing content falls within the scope of this application.

When the integrated unit is implemented in the form of the software functional unit and sold or used as an independent product, the integrated unit may be stored in a readable storage medium. Based on such an understanding, the technical solutions of embodiments of this application essentially, or the part contributing to the conventional technology, or all or some of the technical solutions may be implemented in a form of a software product. The software product is stored in a storage medium and includes several instructions for instructing a device (which may be a single-chip microcomputer, a chip, or the like) or a processor (processor) to perform all or some of the operations of the methods described in embodiments of this application. The foregoing storage medium includes any medium that can store program code, for example, a USB flash drive, a removable hard disk, a read-only memory (ROM), a random access memory (RAM), a magnetic disk, or an optical disc.

Method or algorithm operations described with reference to content disclosed in embodiments of this application may be implemented by hardware, or may be implemented by a processor by executing software instructions. The software instructions may include a corresponding software module. The software module may be stored in a random access memory (RAM), a flash memory, a read-only memory (ROM), an erasable programmable read-only memory (EPROM), an electrically erasable programmable read-only memory (EEPROM), a register, a hard disk, a removable hard disk, a compact disc read-only memory (CD-ROM), or any other form of storage medium well-known in the art. For example, the storage medium is coupled to a processor, so that the processor can read information from the storage medium and write information into the storage medium. Certainly, the storage medium may alternatively be a component of the processor. The processor and the storage medium may be located in an ASIC.

A person skilled in the art should be aware that in the foregoing one or more examples, functions described in embodiments of this application may be implemented by hardware, software, firmware, or any combination thereof. When the software is used to implement the functions, the functions may be stored in a computer-readable medium or transmitted as one or more instructions or code in the computer-readable medium. The computer-readable medium includes a computer-readable storage medium and a communication medium, where the communication medium includes any medium that enables a computer program to be transmitted from one place to another. The storage medium may be any usable medium accessible to a general-purpose or dedicated computer.

The foregoing describes embodiments of this application with reference to the accompanying drawings. However, this application is not limited to the foregoing specific implementations. The foregoing specific implementations are merely examples, but are not limitative. Inspired by this application, a person of ordinary skill in the art may further make modifications without departing from the purposes of this application and the protection scope of the claims, and all the modifications shall fall within the protection of this application.

What is claimed is:

1. An electronic device, comprising:
a memory and a processor, wherein the memory is coupled to the processor; and
the memory stores program instructions, and when the program instructions are executed by the processor, the electronic device is enabled to perform operations comprising:
obtaining a source audio signal, a sound source position corresponding to the source audio signal in a virtual scene, and a first position corresponding to a user in the virtual scene, wherein the virtual scene is obtained through construction based on a real scene;
obtaining a first acoustic feature, wherein the first acoustic feature is obtained by converting, based on an acoustic feature at a second position in the real scene and an acoustic feature at the second position in the virtual scene, an acoustic feature at the first position in the virtual scene when the source audio signal is at the sound source position; and
generating a spatial audio signal based on the first acoustic feature and the source audio signal.

2. The electronic device according to claim 1, wherein
the first acoustic feature comprises at least one of the following: an acoustic response, energy information, an acoustic parameter, or a derived acoustic feature.

3. The electronic device according to claim 1, wherein there are one or more second positions.

4. The electronic device according to claim 1, wherein first positions corresponding to the user in the virtual scene at different moments are the same or different.

5. The electronic device according to claim 1, wherein the second position is the same as or different from the first position.

6. The electronic device according to claim 1, wherein the spatial audio signal generated based on the first acoustic feature and the source audio signal is different from a spatial audio signal generated based on the acoustic feature at the first position in the virtual scene and the source audio signal.

7. The electronic device according to claim 1, wherein the electronic device is enabled to further perform operations comprising:
obtaining a user-defined acoustic feature at the second position in the real scene.

8. The electronic device according to claim 1, wherein the electronic device is enabled to further perform operations comprising:
before obtaining the source audio signal, the sound source position corresponding to the source audio signal in the virtual scene, and the first position corresponding to the user in the virtual scene,
obtaining a user operation performed by the user on a user interface; and
generating the acoustic feature at the second position in the real scene based on the user operation.

9. The electronic device according to claim 1, wherein the electronic device is enabled to further perform operations comprising:
before obtaining the source audio signal, the sound source position corresponding to the source audio signal in the virtual scene, and the first position corresponding to the user in the virtual scene,
obtaining position information of the user; and
when it is determined based on the position information that the user moves to the second position, generating the acoustic feature at the second position in the real scene.

10. The electronic device according to claim 1, wherein the electronic device is enabled to further perform operations comprising:
obtaining the acoustic feature at the second position in the real scene based on the sound source position, the first position, and the second position.

11. An electronic device, comprising:
a memory and a processor, wherein the memory is coupled to the processor; and
the memory stores program instructions, and when the program instructions are executed by the processor, the electronic device is enabled to perform operations comprising:
obtaining a source audio signal, a sound source position corresponding to the source audio signal in a virtual scene, and a first position corresponding to a user in the virtual scene, wherein the virtual scene is obtained through modeling based on a real scene;
obtaining a first acoustic feature based on the sound source position and the first position, wherein the first acoustic feature is obtained by adjusting a second acoustic feature based on conversion information, the second acoustic feature is obtained by performing acoustic feature extraction based on the first position, the virtual scene, and the sound source position, and the conversion information is used to describe a conversion relationship between acoustic features at a same position in the virtual scene and the real scene; and
generating a spatial audio signal based on the first acoustic feature and the source audio signal.

12. A chip, comprising one or more interface circuits and one or more processors, wherein the one or more processors receive or send data through the one or more interface circuits, and when the one or more processors execute computer instructions, the one or more processors cause operations to be performed, the operations comprising:
obtaining a source audio signal, a sound source position corresponding to the source audio signal in a virtual scene, and a first position corresponding to a user in the virtual scene, wherein the virtual scene is obtained through construction based on a real scene;
obtaining a first acoustic feature, wherein the first acoustic feature is obtained by converting, based on an acoustic feature at a second position in the real scene and an acoustic feature at the second position in the virtual scene, an acoustic feature at the first position in the virtual scene when the source audio signal is at the sound source position; and
generating a spatial audio signal based on the first acoustic feature and the source audio signal.

13. The chip according to claim 12, wherein
the first acoustic feature comprises at least one of the following: an acoustic response, energy information, an acoustic parameter, or a derived acoustic feature.

14. The chip according to claim 12, wherein there are one or more second positions.

15. The chip according to claim 12, wherein first positions corresponding to the user in the virtual scene at different moments are the same or different.

16. The chip according to claim 12, wherein the second position is the same as or different from the first position.

17. The chip according to claim 12, wherein the spatial audio signal generated based on the first acoustic feature and the source audio signal is different from a spatial audio signal generated based on the acoustic feature at the first position in the virtual scene and the source audio signal.

18. The chip according to claim 12, wherein the operations further comprise:
obtaining a user-defined acoustic feature at the second position in the real scene.

19. The chip according to claim 12, wherein the operations further comprise:
before obtaining the source audio signal, the sound source position corresponding to the source audio signal in the virtual scene, and the first position corresponding to the user in the virtual scene,
obtaining a user operation performed by the user on a user interface; and
generating the acoustic feature at the second position in the real scene based on the user operation.

20. The chip according to claim 12, wherein the operations further comprise:
before obtaining the source audio signal, the sound source position corresponding to the source audio signal in the virtual scene, and the first position corresponding to the user in the virtual scene,
obtaining position information of the user; and
when it is determined based on the position information that the user moves to the second position, generating the acoustic feature at the second position in the real scene.
